(19) United States
(12) Patent Application Publication
(10) Pub. No.: US 2013/0152292 A1
(43) Pub. Date: Jun. 20, 2013

(54) LIQUID-OPERATED ACTUATOR ASSEMBLY

(71) Applicant: Kwok Chiu Yu, Hong Kong (CN)

(72) Inventor: Kwok Chiu Yu, Hong Kong (CN)

(73) Assignee: Defond Components Limited, Hong Kong (CN)

(21) Appl. No.: 13/330,108

(22) Filed: Dec. 19, 2011

(51) Int. Cl. E03D 1/34; F15B 13/044

(52) U.S. Cl. 4/378; 91/459

(57) ABSTRACT

A liquid-operated actuator assembly includes a valve with an inlet for connection to a source of a liquid, a bi-stable electromagnetic device for operating the valve, and an actuator including a piston in a cylinder. The piston incorporates an actuating member. The cylinder has a chamber on one side of the piston to which the outlet of the valve is connected for receiving the liquid when the valve is opened in order to move the piston and the actuating member to an operative position. An electronic control circuit momentarily energizes the electromagnetic device for operation of the actuating member and to terminate operation of the actuating member.

The present invention relates to a liquid-operated actuator assembly which is particularly, but not exclusively, suitable for use in a toilet cistern.

### BACKGROUND OF THE INVENTION

Battery-operated actuator assembly is known for use in controlling the flow of water in the toilet. Taking as an example, automatic facets will, upon detection of the hands of a user, open and supply water for a certain period of time. These facets are operated by battery cells. As the power consumption is generally not low, the battery life is usually short and hence replacement of battery cells can be frequent.

The invention seeks to mitigate or to at least alleviate such a problem or shortcoming by providing a liquid-operated actuator assembly.

### SUMMARY OF THE INVENTION

According to a first aspect of the invention, there is provided a liquid-operated actuator assembly comprising a valve having an inlet and an outlet, the inlet being for connection to a liquid source, a bi-stable electromagnetic device for operating the valve, the bi-stable electromagnetic device having a first state closing the valve and a second state opening the valve, and an actuator comprising a piston in a cylinder. The piston incorporates an actuating member. The cylinder has a chamber on one side of the piston to which the outlet of the valve is connected for receiving liquid flowing from a said liquid source when the valve is opened by the bi-stable electromagnetic device in order to act upon for moving the piston and in turn the actuating member from an inoperative position to an operative position and for holding the actuating member in the operative position. Included is an electronic control circuit for momentarily energizing the bi-stable electromagnetic device to change it from the first state to the second state for operation of the actuating member and subsequently from the second state back to the first state to terminate operation of the actuating member.

Preferably, the bi-stable electromagnetic device comprises a latching solenoid.

Preferably, the chamber includes a pressure limiter for limiting pressure of liquid received in the chamber acting upon the piston.

More preferably, the pressure limiter comprises a leak in the cylinder positioned for exposure to the chamber when the actuating member reaches the operative position.

Further more preferably, the leak is provided by a hole through a wall of the cylinder.

It is preferred that said liquid received in the chamber is arranged to be flowing through the chamber while exerting a non-static pressure upon the piston when the actuating member reaches the operative position.

It is preferred that the valve includes a pilot valve.

In a preferred embodiment, the liquid-operated actuator assembly includes a draining device for draining said liquid from the chamber upon termination of operation of the actuating member, as the actuating member returns to the inoperative position.

More preferably, the draining device comprises a spring-loaded valve.

Further more preferably, the spring-loaded valve is arranged to be closed by said liquid when said liquid is flowing and to self-open when said liquid stops flowing.

More preferably, the draining device is provided in a path running between the valve and the cylinder.

Advantageously, all the aforesaid mechanical components are interconnected in a one-piece structure.

Preferably, the piston is freely slidable, without bias, in opposite directions along the cylinder.

In a preferred embodiment, the electronic control circuit includes an electrical switch for operating the bi-stable electromagnetic device.

Preferably, the electronic control circuit is battery-operated.

It is preferred that the liquid-operated actuator assembly includes a reservoir for collecting said liquid leaking out through the leak.

It is preferred that the liquid-operated actuator assembly includes a reservoir for collecting said liquid draining out through the draining device.

It is further preferred that the reservoir is arranged to also collect leaking out through the leak.

According to a second aspect of the invention, there is provided a toilet cistern incorporating the aforesaid liquid-operated actuator assembly, including a body acting as a or the reservoir for holding water for flushing, and a flushing mechanism comprising a flushing valve located at a bottom of the body for flushing water held in the body. The flushing valve is operable upon being lifted by the actuating member as the actuating member is moved from the inoperative position to the operative position.

Preferably, the flushing valve is coupled to the actuating member by means of a mechanism that includes a hinge for adapting the movement of the actuating member to lifting of the flushing valve.

Preferably, the actuating member is arranged to support partially the weight of the flushing valve when the actuating member is moving from the inoperative position to the operative position while lifting the flushing valve, and later to return to the inoperative position under the action of the weight of the flushing valve.

According to a third aspect of the invention, there is provided a flushing toilet incorporating the aforesaid toilet cistern, including a toilet bowl to which the toilet cistern is close coupled.

### BRIEF DESCRIPTION OF DRAWINGS

The invention will now be more particularly described, by way of example only, with reference to the accompanying drawings, in which:

FIG. 1 is a schematic diagram of an embodiment of a liquid-operated actuator assembly in accordance with the invention, which is installed for operation in a toilet cistern;

FIG. 2 is an exploded perspective view of the liquid-operated actuator assembly of FIG. 1;

FIG. 3 is a cutaway perspective view of the liquid-operated actuator assembly of FIG. 2;

FIG. 4 is a schematic cross-sectional side view of the liquid-operated actuator assembly of FIG. 3;

FIGS. 5 to 11 are schematic cross-sectional front views of the liquid-operated actuator assembly of FIG. 4, shown in sequential operating conditions;

FIG. 12 is a front perspective view of the toilet cistern and liquid-operated actuator assembly of FIG. 1, showing the actuator assembly in an inoperative condition;

FIG. 13 is a front view of the liquid-operated actuator assembly of FIG. 12;

FIG. 14 is a front perspective view of the toilet cistern and liquid-operated actuator assembly corresponding to FIG. 12, showing the actuator assembly in an operative condition; and

FIG. 15 is a front view of the liquid-operated actuator assembly of FIG. 14.

### DETAILED DESCRIPTION OF PREFERRED EMBODIMENT

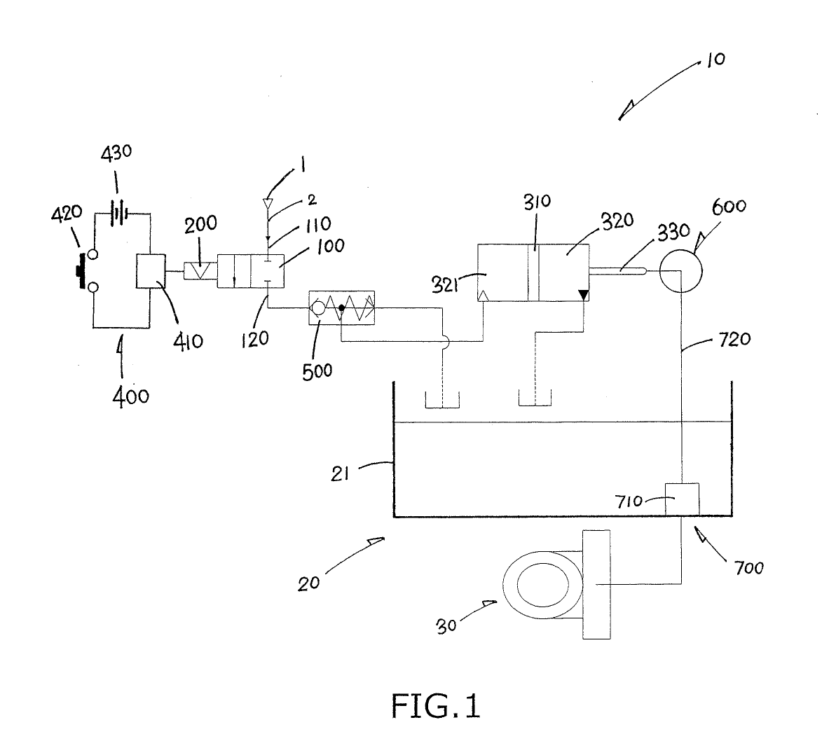

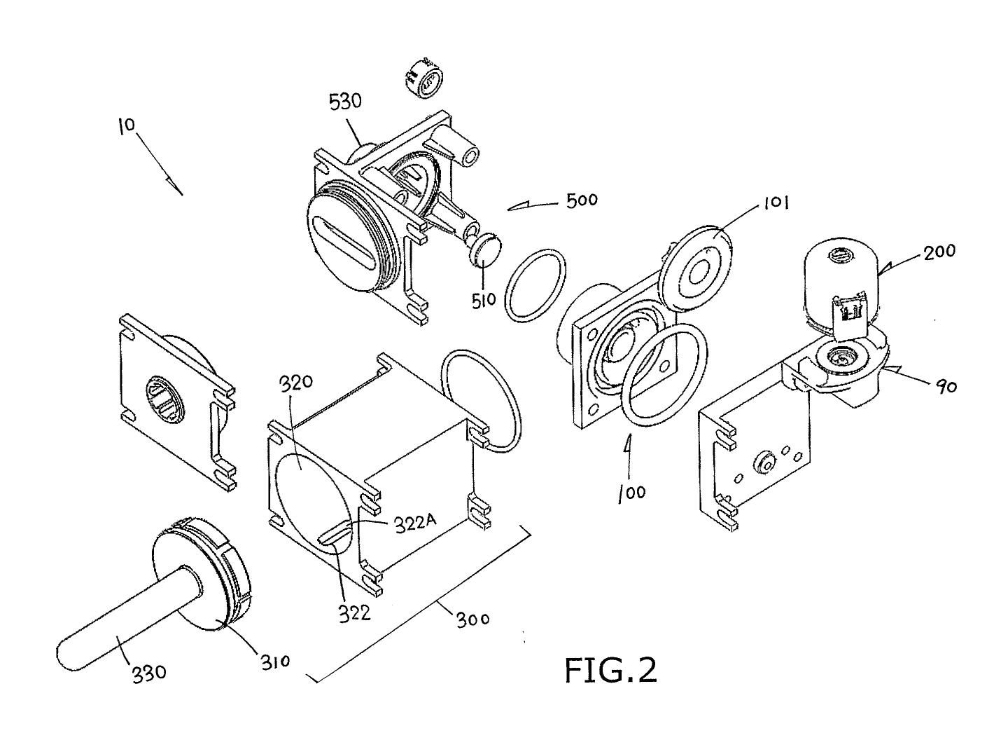

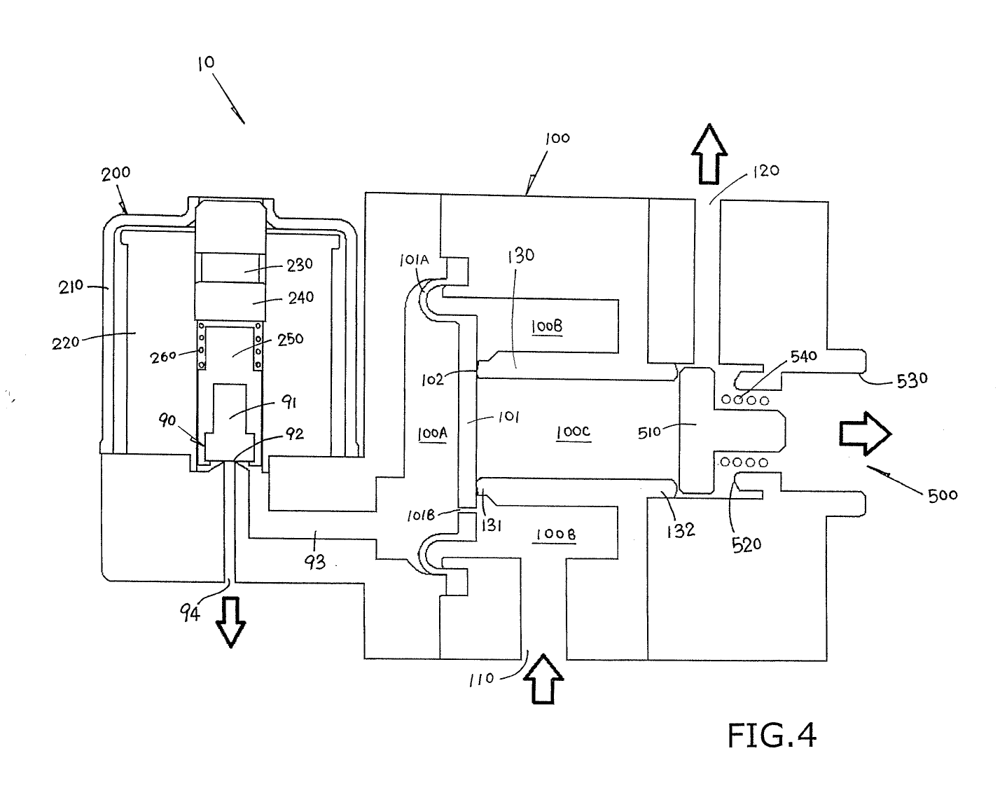

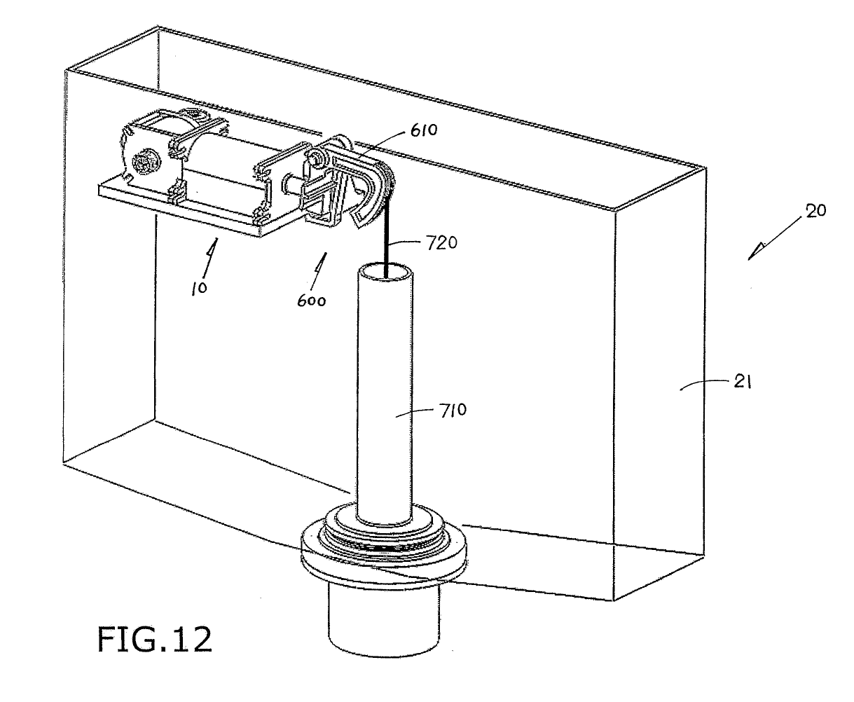

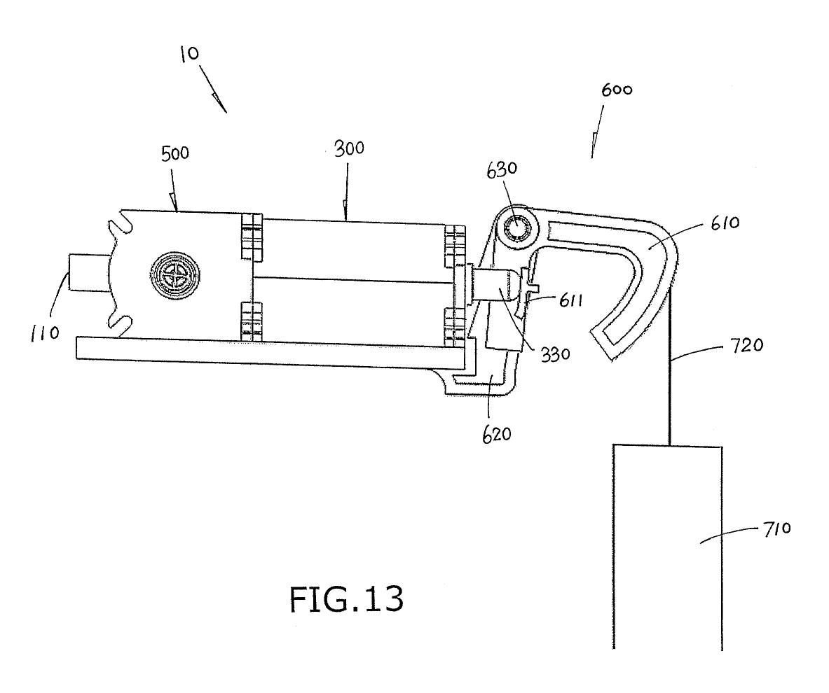

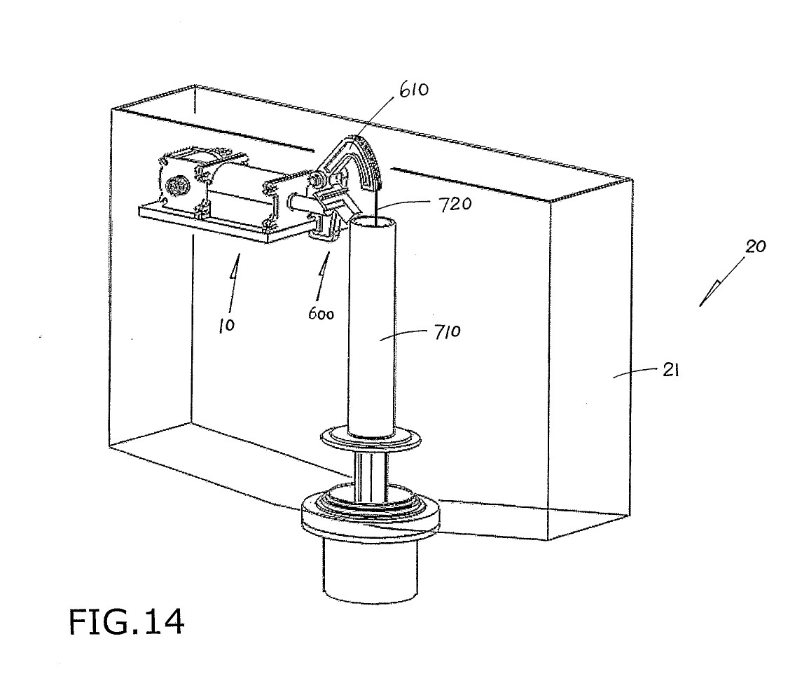

Referring to FIGS. 1 to 15 of the drawings, there is shown a liquid-operated actuator assembly 10 installed in a toilet cistern 20 employing the invention. The actuator assembly 10 comprises a valve 100 having an inlet 110 and an outlet 120, a bi-stable electromagnetic device 200 for operating the valve 100, an actuator 300 having a piston 310 in a cylinder 320, and an electronic control circuit 400 for energizing the electromagnetic device 200. The valve inlet 110 is for (direct or indirect) connection to a water source e.g. a tap water (or flush water) supply 1 by means of a pipe 2 for supply of water to operate the actuator 300.

The electromagnetic device 200 is preferably implemented by a bi-stable or latching solenoid 200 having a first state closing the valve 100 and a second state opening the valve 100. The latching solenoid 200 has a cylindrical iron casing 210, a solenoid coil 220 within the casing 210 and, along a central axis of the casing 210, a pole piece 240, a permanent magnet 230 located between the casing 210 and an inner end of the pole piece 240, and a spring-loaded plunger 250 adjacent an outer end of the pole piece 240. The plunger 250 is resiliently biased by a coil spring 260 compressed between the plunger 250 and the pole piece 240, at a small distance off the pole piece 240 in an unlatched position. The permanent magnet 230 has a magnetic field which is in line with that of the solenoid coil 220 in one polarity but counteracted by the coil's magnet field in the reversed polarity.

In operation, when the solenoid coil 220 is energized (e.g. by a positive electrical pulse) in the same polarity as the permanent magnet 230, the plunger 250 will be attracted to slide towards and against the pole piece 240 through a very short stroke and stay in such a latched position, i.e. the second state holding the valve 100 open, even if the energizing voltage is switched off. Later, after for example six to nine seconds, when the solenoid coil 220 is energized in the reversed polarity (e.g. by a negative electrical pulse), its magnetic field will counteract and neutralize the magnetic field of the permanent magnet 230, thereby releasing the plunger 250, which will then return to its original unlatched position, i.e. the first state holding the valve 100 closed, under the action of the spring 260. The latching solenoid 200 does not consume power to stay in the first state, thereby holding the valve 100 normally closed.

The valve 100 is hereinafter referred to as the main valve 100, which is controlled by a considerably smaller, and less powerful, pilot valve 90 installed immediately in front of the plunger 250. The pilot valve 90 is formed by a valve member 91 embedded in the plunger 250 and a valve seat 92 against which the valve member 91 normally presses. Externally, the pilot valve 90 has an inlet port 93 and an outlet port 94 which are in communication with each other via a passage 93-94 through the valve seat 92 such that the passage 93-94 is controlled by the pilot valve 90 and hence by the latching solenoid 200. The passage 93-94 is normally closed.

As to construction, the main valve 100 is formed by a valve member 101 against which a valve seat 102 normally presses, and includes a cylindrical core 130 whose one end 131 acts as the valve seat 102 and opposite end 132 leads to the main valve outlet 120. The valve member 101 is a flat rubber disc which, while normally bearing flat against and hence sealing with the valve seat 102, has a flexible periphery 101A of a reduced thickness and bent cross-section such that the valve member 101 is retractable to disengage from the valve seat 102.

The valve member 101 extends across the interior of the main valve 100 and divides the same into a front interior or chamber 100A and a rear interior which is further divided by the cylindrical core 130 into an outer chamber 100B surrounding the core 130 and an inner chamber 100C extending through the core 130. The front chamber 100A is in communication with the inlet 93 of the pilot valve 90, and the outer and inner chambers 100B and 100C with the main valve inlet 110 and outlet 120 respectively.

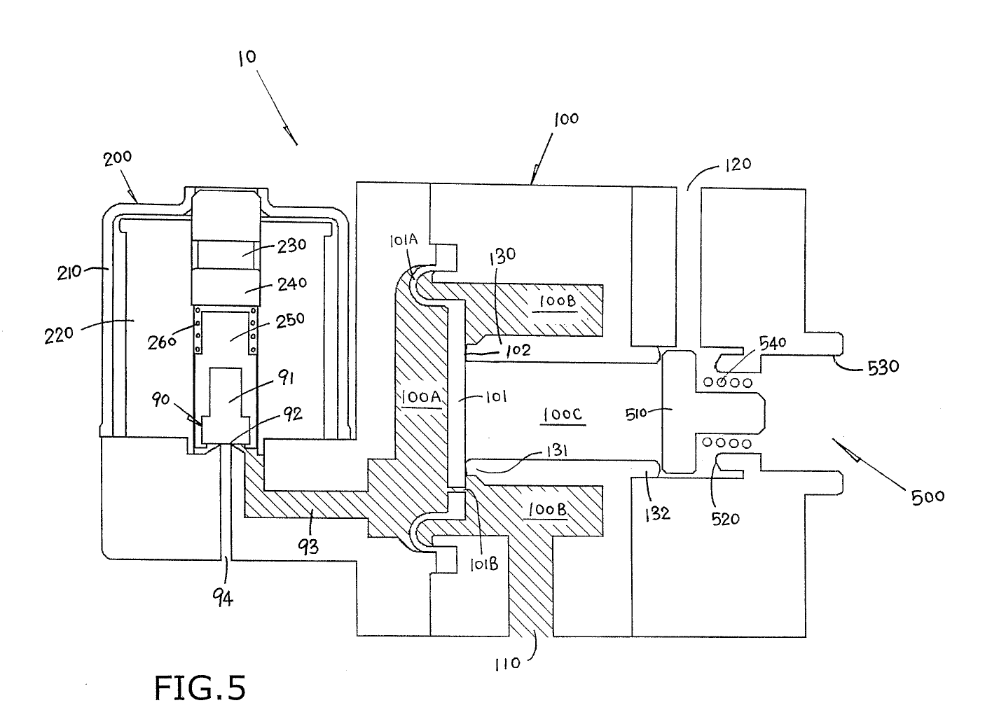

A small hole 101B through the valve member 101 equalizes the pressure between the front and outer chambers 100A and 100B when the pilot valve 90 is closed holding water in the front chamber 100A. In this condition, water fed from the water supply 1 into the outer chamber 100B (and also into the front chamber 100A via the hole 101B) is blocked from flowing into the inner chamber 100C by the valve member 101 in sealing engagement with the valve seat 102, i.e. the main valve 100 is closed (FIG. 5).

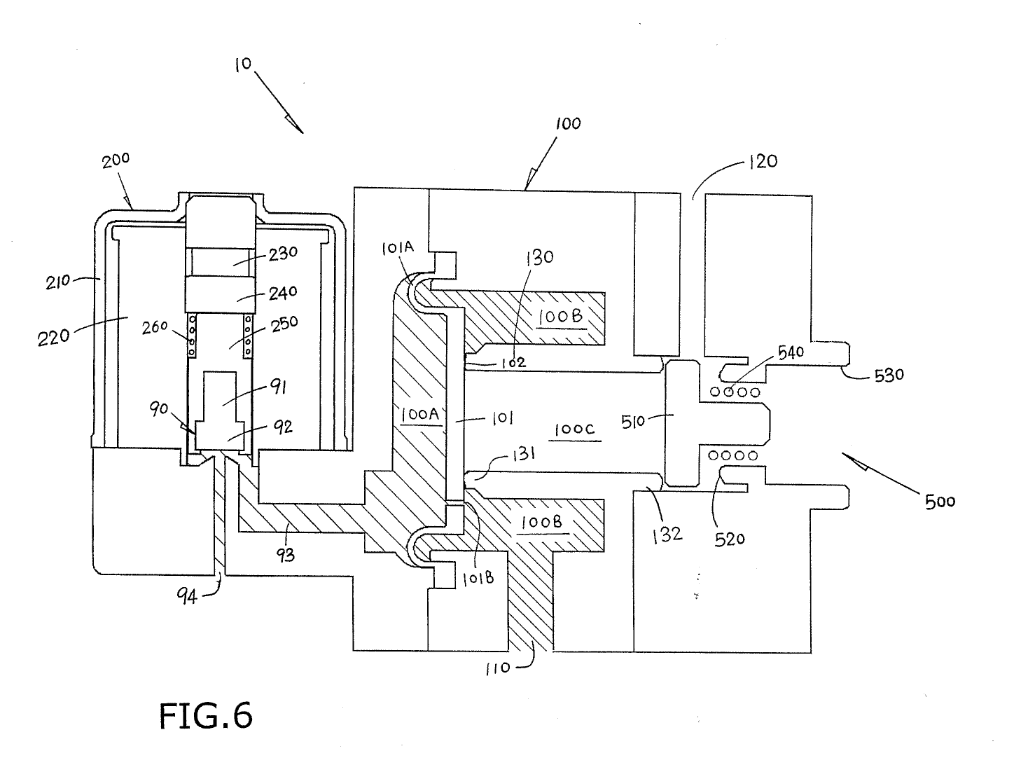

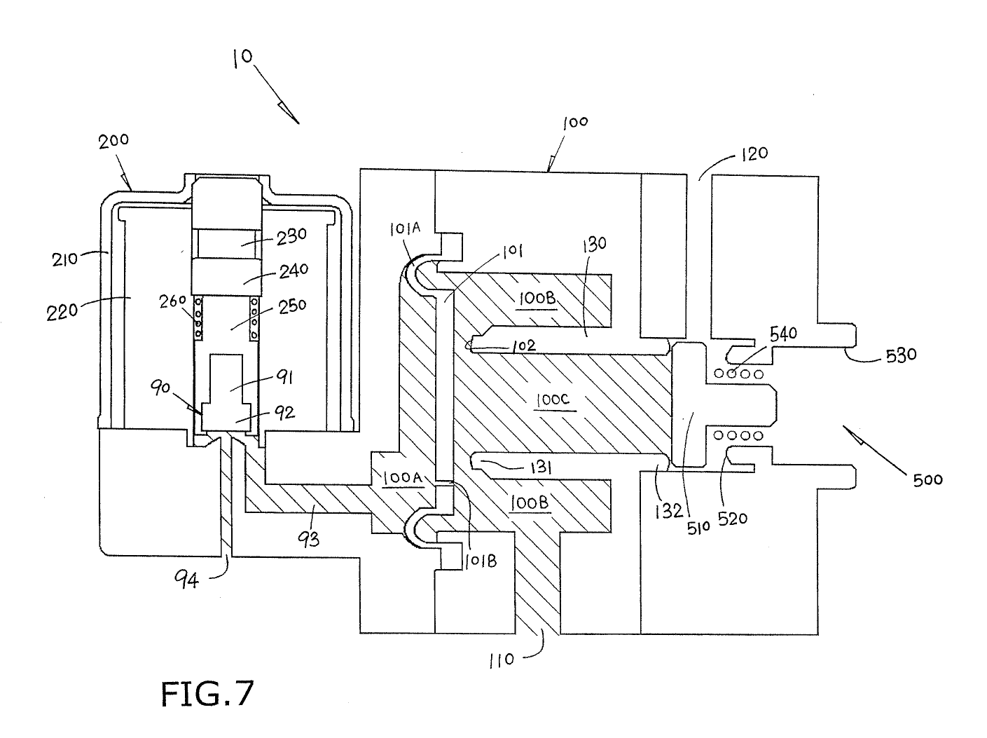

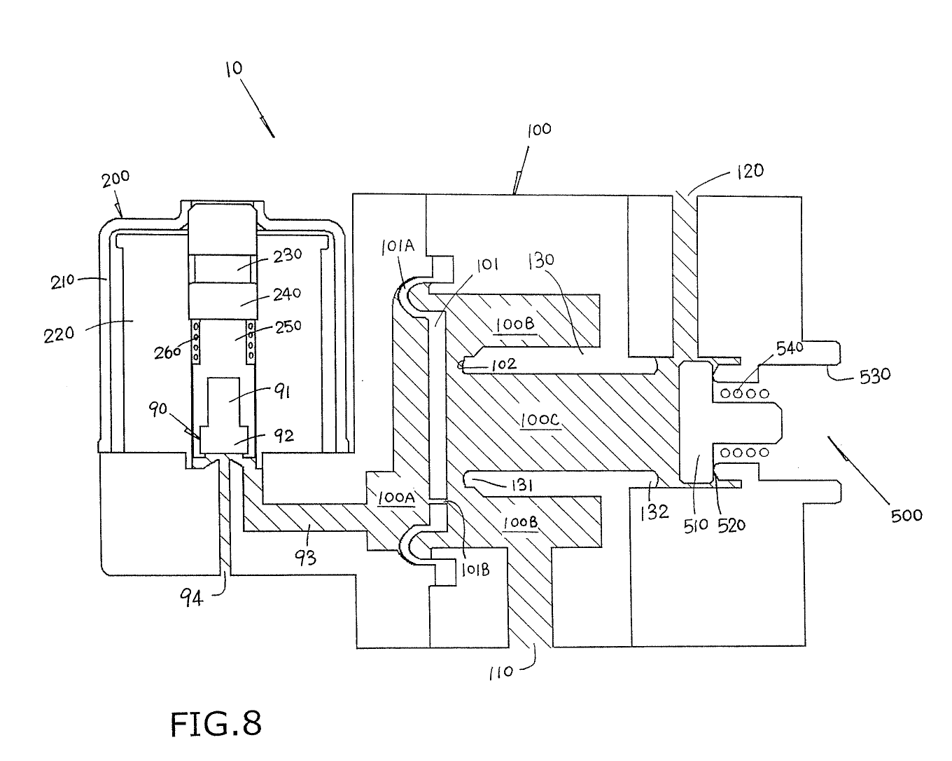

Upon energization, the latching solenoid 100 opens the pilot valve 90, and this results in loss of water from the front chamber 100A through the pilot valve 90 and hence pressure drop in the front chamber 100A (FIG. 6). With water being fed into the outer chamber 100B via the inlet 110 of the main valve 100, the pressure in the outer chamber 100B substantially maintains and hence becomes relatively higher than that in the front chamber 100A. The valve member 101 consequently retracts and disengages from the valve seat 102, thereby giving way to allow water from the outer chamber 100A to flow into the inner chamber 100C (FIG. 7) and hence out of the main valve 100 via its outlet 120 (FIG. 8). The main valve 100 is consequently opened.

The main valve 100 controls the main flow of water from the water supply 1 to operate the actuator 300, at a relatively high pressure or high flow feed. The pilot valve 90 is a smaller valve that controls a limited-flow control feed to the main valve 100, thereby allowing a small and easily operated feed to control a much higher pressure or higher flow feed, which would otherwise require a much larger force to operate. The pilot valve 90 is used to enable the use of a relatively less powerful latching solenoid 200.

Alternatively, in another embodiment of the liquid-operated actuator assembly 10 of a simpler construction, a relatively more powerful or sufficiently powerful latching solenoid (200) is employed to directly operate the main valve (100) for controlling the main flow of water, thereby eliminating the need of using a pilot valve (90).

As to the actuator 300, the cylinder 320 is oriented with its central axis extending horizontally. The piston 310 is freely slidable, under no specific biasing force (for simplicity and as is unnecessary in the circumstances), in opposite directions and co-axially along the central axis of the cylinder 320. The piston 310 is fitted with an actuating member in the form of an actuating or push rod 330 which projects from the piston 310 along its central axis and out through a front end of the cylinder 320. The cylinder 320 has a rear chamber 321 on the rear side (i.e. one side) of the piston 310, to which chamber 321 the outlet 120 of the main valve 100 is in communication (or connected indirectly) for receiving water from the water supply 1 when the main valve 100 is opened by the latching solenoid 200.

Water entering the rear chamber 321 acts upon the piston 310 for moving the piston 310 and in turn extending the push rod 330 forward from an inner inoperative position to an outer operative position, thereby performing a push action, and for subsequently holding the push rod 330 in the operative position i.e. extended.

The cylinder 320 has a linear slot 322 extending axially at the lowest position of its horizontally-lying cylindrical wall. The slot 322 extends from its one end situated at the front end of the cylinder 320 for a certain length greater than the thickness of the piston 310 such that its other end 322A will be exposed to the rear chamber 321 right behind the piston 310 when the piston 310 is pushed by water in the rear chamber 321 to reach a forward-most position in the cylinder 320, where it locates the push rod 330 in the latter's operative position. The slot's exposed end 322A is a hole that represents a leak through the wall of the cylinder 320, for the rear chamber 321, when the push rod 330 reaches its operative position.

Upon exposure of such a leak to the rear chamber 321, the water in the chamber 321 finds its way out of the cylinder 320. The leak is of an optimum size, i.e. not too large and not too small, just sufficient to limit the pressure of the water in the rear chamber 321 acting upon the piston 310 at a certain level while water is being continuously replenished from the water source 1 via the main valve 100 and flowing through the chamber 321. While flowing in the rear chamber 321, the water exerts a non-static pressure upon the piston 310 when the push rod 330 reaches its operative position, which is sufficient to keep the push rod 300 in the operative position.

The leak acts as a pressure limiter for water in the rear chamber 321 of the cylinder 320. It avoids over-pressure in the rear chamber 321, which otherwise may thrust the piston 310 too hard against the front end of the cylinder 320 and shatter the cylinder 320.

The control circuit 400 is implemented by an MCU 410 connected with an electrical switch provided by, for example, a pushbutton switch 420, and is battery-operated by one or more battery cells 430. The MCU 410 has an output pin connected to the latching solenoid 200 for operating the solenoid 200 by momentarily energizing the solenoid 200 with an electrical signal to change it from the first state (closing the valve 100) to the second state (opening the valve 100) thereby triggering the operation of the push rod 330 and, subsequently after a predetermined period of time of operation has elapsed (e.g. 10 seconds) with another electrical signal to change the solenoid 200 from the second state back to the first state for terminating the operation of the push rod 330.

The first electrical signal may be a positive electrical pulse, and the second electrical signal a negative electrical pulse, both having a pulse width of about 20 ms (millisecond). The duration of the electrical pulses is sufficiently long (say at least 5 ms) for the valve member 101 of the main valve 100 to respond (i.e. changing position relative to the valve seat 102) to the opening/closing of the pilot valve 90.

The push rod 330 is arranged to return to its original inoperative position, i.e. to recede, upon expiration of the aforesaid predetermined period of time of operation. The push rod 330 is only able to recede when the water behind the piston 310 gives way or, for example, is drained as in the case of the described embodiment. A draining device 500 is employed for this purpose, which kicks in upon termination of operation of the push rod 330, as the push rod 330 returns or is returning to the inoperative position.

The draining device 500 is a spring-loaded drain valve 500 provided in a path running between the main valve 100 and the cylinder 320 of the actuator 300. The drain valve 500 comprises a cylindrical valve seat 520 formed immediately behind a circular drain hole 530 and a mushroom-like valve member 510 engageable with the valve seat 520 against the action of a coil spring 540, all four parts being in co-axial alignment. The drain valve 500 is normally-open. Its valve member 510 is positioned immediately outside and is co-axially aligned with the end 132 of the cylindrical core 130 of the main valve 100, at a junction with a first path leading straight to the drain hole 530 and a second path leading at right angles to the main valve's outlet 120.

While flowing through the main valve 100 into the cylinder 310 of the actuator 300, the water just leaving the main valve's core 130 (en route to the outlet 120) hits and presses upon the valve member 510 head-on and thus closes the drain valve 500 (FIG. 8). The drain valve 500 will remain closed for as long as the water is running to the actuator 300.

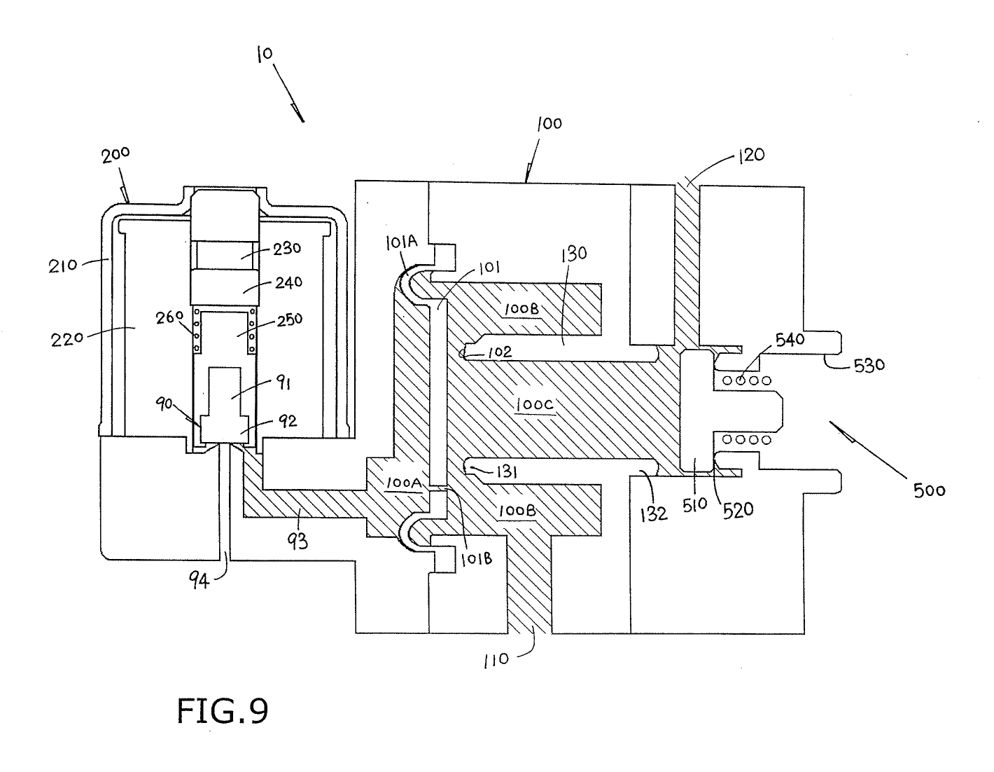

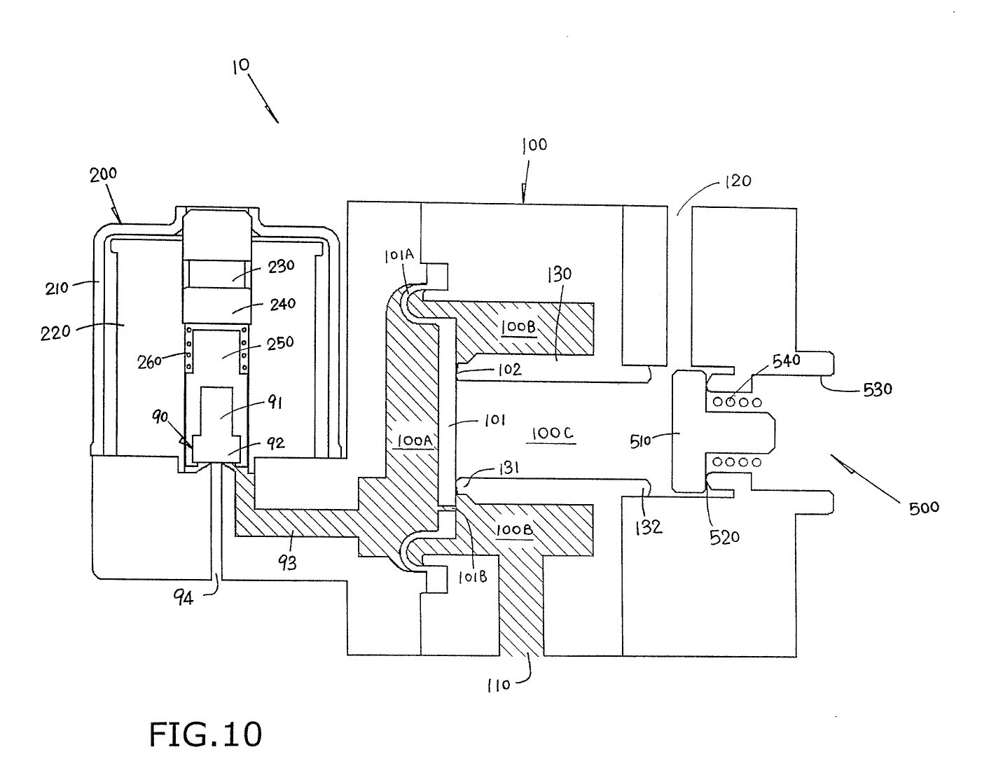

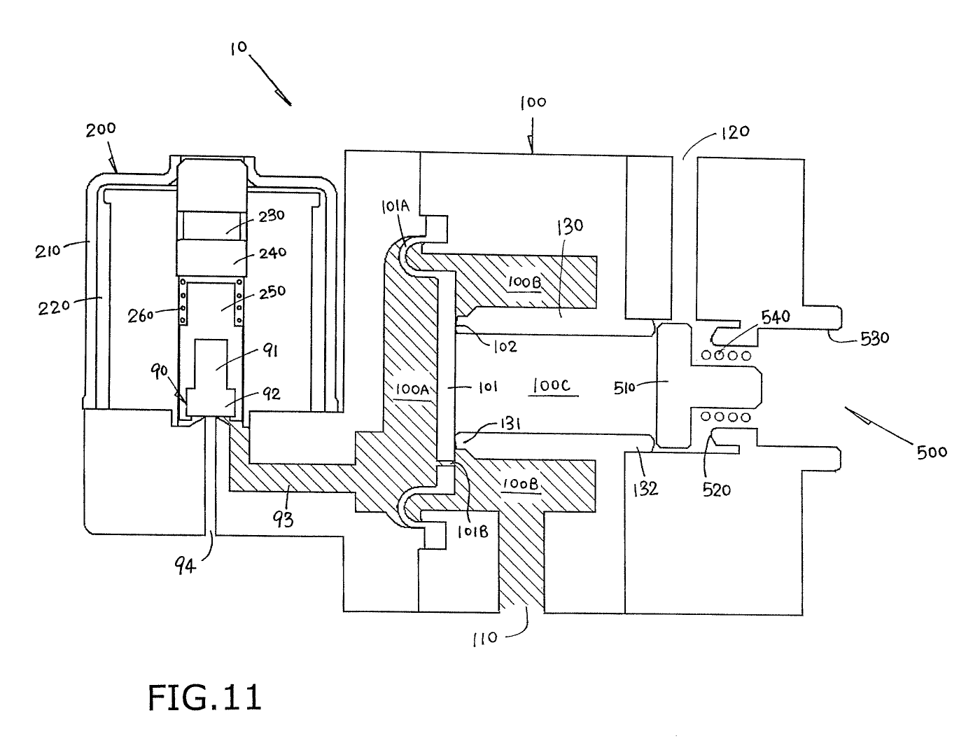

At the end of the aforesaid predetermined period of time of operation, the latching solenoid 200 is energized to close the pilot valve 90 (FIG. 9) and in turn also the main valve 100 (FIG. 10), thereby stopping the flow of water from the water supply 1 into the subject actuator assembly 10. Water pressure disappears immediately, and this at once leads to two consequences, namely cessation of the push action of the push rod 330 and self re-opening of the drain valve 500 (FIG. 11).

The push rod 300 immediately returns to its inoperative position under the action of a force (e.g. an external force as hereinafter described), causing the piston 310 to press the water in the rear chamber 321 of the actuator's cylinder 320 out and back into the main valve 100 via the latter's outlet 120. With the drain valve 500 now open, the water escapes and drains out of the liquid-operated actuator assembly 10. The actuator assembly 10 then will return or is reset to its original condition ready for the next operation.

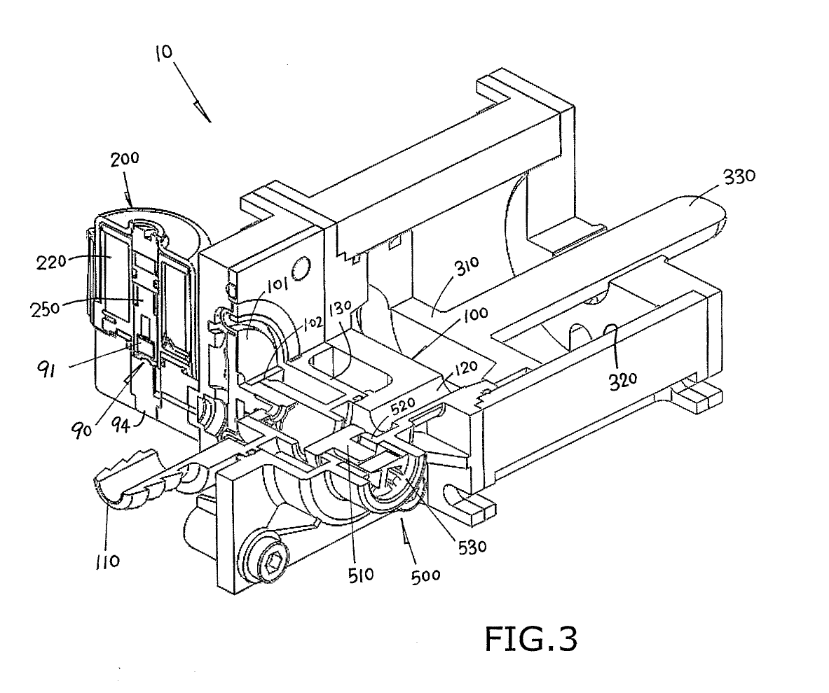

All the aforesaid mechanical parts or components, namely the main valve 100, pilot valve 90, latching solenoid 200, actuator 300 and drain valve 500 of the actuator assembly 10 are assembled in a one-piece structure or housing, as best shown in FIG. 3.

In this particular embodiment, the actuator assembly 10 further includes a hinged mechanism 600 for changing the direction of action of the push rod 330. The hinge mechanism 600 is formed by a C-shaped bracket 610 connected to a base 620 by means of a hinge 630 for pivotal movement relative thereto. The base 620 is mounted on the aforesaid one-piece housing immediately in front of and about the push rod 330, such that the push rod 300 is aligned to engage, and push, the bracket 610 by a small pedal 611 of the bracket 610.

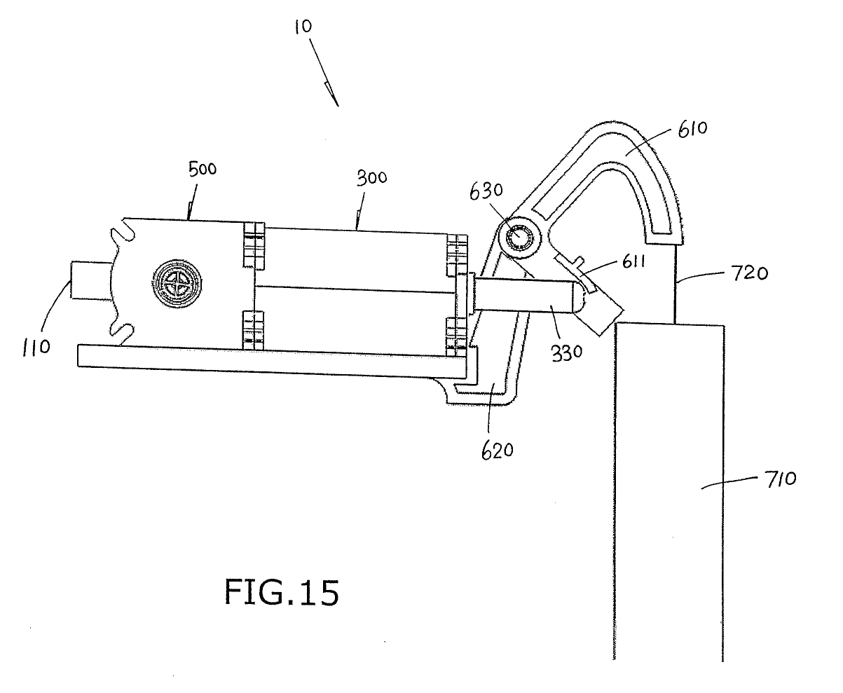

As the push rod 300 is extended from the inoperative position to the operative position, it pivots the hinged bracket 610 upwardly anti-clockwise to an upper operative position (FIG. 15). Later, the bracket 610 may pivot or be pivoted downwardly clockwise back to a lower inoperative position, thereby pushing and returning the push rod 330 back to the inoperative position. The hinged bracket 610 acts as a modified actuating member of the actuator 300, which operates in a different manner and/or direction compared to the push rod 330.

The liquid-operated actuator assembly 10 is intended for installation and use, as one of its preferred applications, in a toilet cistern 20 which may be close coupled to a toilet bowl 30. The toilet cistern 20 has a body or tank 21 acting as a reservoir for holding water for flushing, and includes a flushing mechanism 700 which comprises a flushing valve 710 located at the bottom of the tank 21 for flushing water out of the tank 21. The actuator assembly 10 is mounted within a top opening of the tank 21. A string or chain 720 connects or couples an uppermost end of the flushing valve 710 to a tip of the hinged bracket 610 of the hinge mechanism 600 of the actuator assembly 10.

The flushing valve 710 is operable upon being lifted by the hinged bracket 610 (acting as a modified actuating member) as the bracket 610 is pivoted from the lower to the upper position corresponding to the inoperative and operative positions of the push rod 330. The valve 710 operates by being opened wide to let water to rush down from the tank 21 into the toilet bowl 30, thereby performing a flush cycle which should take about six to nine seconds to complete.

The hinge mechanism 600 includes a hinge for adapting the horizontal movement of the push rod 330 to vertical lifting upon the flushing valve 710. The hinged bracket 610 is arranged to support the weight of the flushing valve 710 (in the water) when it is being pivoted from the lower inoperative position to the upper operative position, while lifting and hence opening the flushing valve 710.

Upon completion of the flush cycle (i.e. about six to nine seconds later), by virtue of gravitational force, the bracket 610 is later returned to the lower position under the action of the weight of the flushing valve 710. This returns or resets the actuator assembly 10 to its original condition ready for the next flushing operation.

During operation of the actuator assembly 10, water leaking out through the exposed hole 322A of the actuator 300 and water draining out through the drain valve 600, as well as water loss from the pilot valve 90, is all collected in the same reservoir below provided by the tank 21 of the toilet cistern 20.

The liquid-operated actuator assembly, or the actuator in short, of the subject invention is powered by the tap or flush water. A bi-stable electromagnetic device, e.g. an electrical latching solenoid valve, is used to control the water flow from the water supply. While the solenoid valve is opened, it lets in water which then triggers the actuator to operate the flushing valve, thereby letting water in the cistern to discharge immediately into the toilet bowl and flush away waste in the bowl. This arrangement utilizes the supply water pressure as the major power source to complete the toilet flushing operation.

The bi-stable electromagnetic device only requires an electrical signal of a limited duration to change state. Once latched, the latching solenoid will stay in the latched position without the need of electrical power and hence the power source is turned off. Power consumption is therefore low and this enables use of battery power to control the actuator itself operated by the supplied water. Since the flushing mechanism is powered by the supply water pressure, the power consumption of the control electronics and latching solenoid is extremely low. The invention makes it possible for a battery-operated toilet flushing system to function with a reasonable operating time before battery runs flat. By calculation, a battery cell can trigger over 30,000 times flushing cycles in 3.5 years of normal use.

The invention has been given by way of example only, and various other modifications of and/or alterations to the described embodiments may be made by persons skilled in the art without departing from the scope of the invention as specified in the appended claims.

1. A liquid-operated actuator assembly comprising:
a valve having an inlet and an outlet, the inlet being for connection to a liquid source;
a bi-stable electromagnetic device for operating the valve, the bi-stable electromagnetic device having a first state closing the valve and a second state opening the valve;
an actuator comprising a piston in a cylinder, the piston incorporating an actuating member, the cylinder having a chamber on one side of the piston to which the outlet of the valve is connected for receiving a liquid flowing from the liquid source when the valve is opened by the bi-stable electromagnetic device for moving the piston, and, in turn, the actuating member from an inoperative position to an operative position, and for holding the actuating member in the operative position; and
an electronic control circuit for momentarily energizing the bi-stable electromagnetic device to change the bi-stable electromagnetic device from the first state to the second state for operation of the actuating member, and from the second state to the first state to terminate operation of the actuating member.

2. The liquid-operated actuator assembly as claimed in claim 1, wherein the bi-stable electromagnetic device comprises a latching solenoid.

3. The liquid-operated actuator assembly as claimed in claim 1, wherein the chamber includes a pressure limiter for limiting pressure of the liquid received in the chamber acting upon the piston.

4. The liquid-operated actuator assembly as claimed in claim 3, wherein the pressure limiter comprises a leak in the cylinder positioned for exposure to the chamber when the actuating member reaches the operative position.

5. The liquid-operated actuator assembly as claimed in claim 4, wherein the leak is a hole through a wall of the cylinder.

6. The liquid-operated actuator assembly as claimed in claim 1, wherein the liquid received in the chamber flows through the chamber while exerting a non-static pressure upon the piston when the actuating member reaches the operative position.

7. The liquid-operated actuator assembly as claimed in claim 1, wherein the valve includes a pilot valve.

8. The liquid-operated actuator assembly as claimed in claim 1, including a draining device for draining the liquid from the chamber upon termination of operation of the actuating member, as the actuating member returns to the inoperative position.

9. The liquid-operated actuator assembly as claimed in claim 8, wherein the draining device comprises a spring-loaded valve.

10. The liquid-operated actuator assembly as claimed in claim 9, wherein the spring-loaded valve is closed by the liquid when the liquid is flowing and opens when the liquid stops flowing.

11. The liquid-operated actuator assembly as claimed in claim 8, wherein the draining device is located in a path between the valve and the cylinder.

12. The liquid-operated actuator assembly as claimed in claim 1, wherein all the aforesaid mechanical components are interconnected in a one-piece structure.

13. The liquid-operated actuator assembly as claimed in claim 1, wherein the piston is freely slidable, without bias, in opposite directions along the cylinder.

14. The liquid-operated actuator assembly as claimed in claim 1, wherein the electronic control circuit includes an electrical switch for operating the bi-stable electromagnetic device.

15. The liquid-operated actuator assembly as claimed in claim 1, wherein the electronic control circuit is battery-operated.

16. The liquid-operated actuator assembly as claimed in claim 4, including a reservoir for collecting the liquid leaking through the leak.

17. The liquid-operated actuator assembly as claimed in claim 8, including a reservoir for collecting the liquid draining through the draining device.

18. The liquid-operated actuator assembly as claimed in claim 17, wherein the reservoir collects the liquid leaking out through the leak.

19. A toilet cistern comprising:
the liquid-operated actuator assembly as claimed in claim 1;
a body for holding water, as the liquid, for flushing; and
a flushing mechanism comprising a flushing valve located at a bottom of the body for flushing the water held in the body, wherein the flushing valve is operable upon being lifted by the actuating member, as the actuating member is moved from the inoperative position to the operative position.

20. The toilet cistern as claimed in claim 19, wherein the flushing valve is coupled to the actuating member by a hinge for converting movement of the actuating member to lifting of the flushing valve.

21. The toilet cistern as claimed in claim 19, wherein the actuating member partially supports the flushing valve when the actuating member is moving from the inoperative position to the operative position, while lifting the flushing valve, and the actuating member is returned to the inoperative position by lowering of the flushing valve.

22. A flushing toilet incorporating the toilet cistern as claimed in claim 19, including a toilet bowl to which the toilet cistern is coupled.
